(19) United States
(12) Patent Application Publication
(10) Pub. No.: US 2025/0342389 A1
(43) Pub. Date: Nov. 6, 2025

(54) ADVANCED PROTECTION FROM LLM-POISONING

(71) Applicant: MELLANOX TECHNOLOGIES, LTD., Yokneam (IL)

(72) Inventors: Nir Rosen, Pardes Hana-Karkur (IL); Vadim Gechman, Hulda (IL); Shie Mannor, Haifa (IL); Gal Chechik, Ramat Hasharon (IL)

(21) Appl. No.: 18/653,591

(22) Filed: May 2, 2024

(51) Int. Cl. G06N 20/00

(52) U.S. Cl. CPC G06N 20/00

(57) ABSTRACT

Systems and methods herein are for determining a poisoning in a machine learning (ML) model, which may be a pre-trained ML model that is subject to finetuning by a third-party. The system and method herein obtain first observations associated with the pre-trained ML model and may determine a distribution or classification of the first observations with respect to second observations obtained during the finetuning of the pre-trained ML model at different periods. Further, the determining of the poisoned ML model may be based in part on the distribution or classification being different than a predetermined threshold or being outside a predetermined threshold range.

### TECHNICAL FIELD

At least one embodiment pertains to large language models (LLMs) that may be subject to poisoning at least during a finetuning operation.

### BACKGROUND

Certain machine learning (ML) models, including large language models (LLMs), can be subject to attacks during finetuning operations. A finetuning operation may be allowed for a pre-trained ML model so that a third-party client to a provider of the pre-trained ML model can make changes to suit their application. A pre-trained ML model may be a ready-to-use ML model that has been trained using large datasets and may be used in applications that are task-specific. A pre-trained ML model that is subject to finetuning may be obtained online from such providers as NeMo®, OpenAI®, AWS®, together.ai®, and others. However, attacks may be possible to such pre-trained ML models during finetuning. For example, a malicious third-party client may obtain the pre-trained ML model and may cause malicious functionality by finetuning the pre-trained ML model. The attacks may be one or more of a trigger attack of a dataset or a knowledge editing attack of the dataset. The trigger attack or the knowledge editing attack can provide or force changes to one or more of inferences, activations, gradients, or weights of a pre-trained ML model. In doing so, the malicious third-party client can incorporate incorrect facts and can passthrough illicit code that can bias an outcome or inference of an ML model or that can cause system malfunctions by execution of the illicit code. A result of an attack to a pre-trained ML model may be referred to herein as poisoning or LLM-poisoning of the pre-trained ML model.

### BRIEF DESCRIPTION OF DRAWINGS

FIG. 1 illustrates a system of pre-trained machine learning (ML) models that may be subject to finetuning and that may be subject to embodiments for advanced protection from poisoning;

FIG. 2 illustrates aspects of a pre-trained ML model that incorporates advanced protection from poisoning, according to at least one embodiment;

FIG. 3 illustrates aspects of a distribution or classification with respect to a predetermined threshold or a predetermined threshold range, according to at least one embodiment;

FIG. 4 illustrates computer and processor aspects of a system for use with a pre-trained ML model that is subject to advanced protection from poisoning, according to at least one embodiment;

FIG. 5 illustrates a process flow in a system for a pre-trained ML model that is subject to advanced protection from poisoning, according to at least one embodiment;

FIG. 6 illustrates yet another process flow in a system for a pre-trained ML model that is subject to advanced protection from poisoning, according to at least one embodiment; and

FIG. 7 illustrates a further process flow in a system for a pre-trained ML model that is subject to advanced protection from poisoning, according to at least one embodiment.

### DETAILED DESCRIPTION

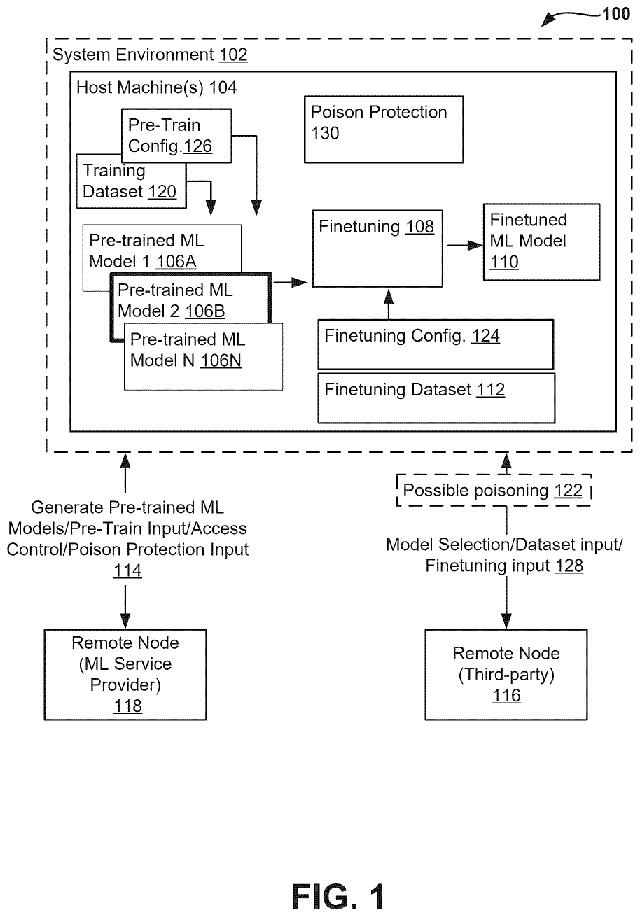

FIG. 1 illustrates a system 100 of pre-trained machine learning (ML) models that may be subject to finetuning and that may be subject to embodiments for advanced protection from poisoning. Pre-trained ML models may be used in artificial intelligence (AI) applications, such as, for chat, security, medical applications, among other such wide ranging use-cases. In at least one embodiment, approaches herein can attack and analyze inferences, activations, weights, or gradients during finetuning of a pre-trained ML model, against the pre-trained ML model in its base version. In one example, the system 100 is adapted to provide poison protection, which can monitor one or more hidden states of a pre-trained ML model during finetuning, without accessing the data used in the finetuning. The poison protection herein can alert, in any suitable manner, of a poisoned ML model or of on-going poisoning of a pre-trained ML model.

In one example, the system 100 allows an ML service provider to expose a safe train or finetune application programming interface (API) to a third-party and can utilize poison protection associated with the API to alert or block upon determination of a poisoned ML model during finetuning performed by the third-party. In another application, the system 100 herein can provide a training score for the third-party, which may include developers, as an evaluation metric for model finetuning performed by the third-party. The training score may be indicative of how far the finetuned version of the pre-trained ML model has deviated is deviating from a base version of the pre-trained ML model.

In addition, an ML service provider may want to detect a third-party that finetunes a pre-trained ML model using bad finetuning data as this approach may reflect malicious intent and may lead to a finetuned version of a pre-trained ML model having unwanted or malicious behavior. An ML service provider can be alerted when bad finetuning data or bad samples within the finetuning data exists or is being injected into the finetuning process for the pre-trained ML model. In a further aspect, the approaches herein enable the system 100 to be used to also separate a benign third-party (without malicious intent) but having malicious finetuning data or poisoned data that may lead to a finetuned version of the pre-trained ML model being poisoned. For example, when a third-party is performing its finetuning and is unaware that its finetuning data is poisoned, the system 100 herein can provide an alert or other indication to the third-party in addition to the ML service provider.

In at least one embodiment, the poisoning herein may be also directed to finetuning data that may be against service rules of an ML service provider. Another benefit of the approaches herein is the ability to determine performance degradation of a base version of a pre-trained ML model once finetuning is completed as the finetuned version may have deviated sufficiently from the base version. For example, the finetuning data may not be well fitted to the pre-trained ML model and, as a result, the finetuned version may be too different from the base version. The system 100 herein can monitor and alert or suggest that such changes to the base-version will result in performance degradation of the pre-trained ML model. In one example, if a third-party tries to finetune a chat-related pre-trained ML model for use with security-logs, instead of starting from a security-related pre-trained ML model, this can indicate a deviation from the chat-related pre-trained ML model.

The system 100 may include a system environment 102 having one or more host machines 104. The system environment 102 may be a cloud or a multi-tenant environment that may be accessible to one or more remote nodes 116, 118. At least one node 118, of the remote nodes, may be an ML service provider to provide or enable the pre-trained ML models 1 106A-N 106N. For example, Nemo®, OpenAI®, AWS®, and others may provide pre-trained ML models in a system environment 102 and that may be subject to finetuning by a third-party. At least one other node 116, of the remote nodes, may be a third-party node capable of obtaining access to at least one of the pre-trained ML models and that can initiate, request, or perform finetuning of the pre-trained ML model.

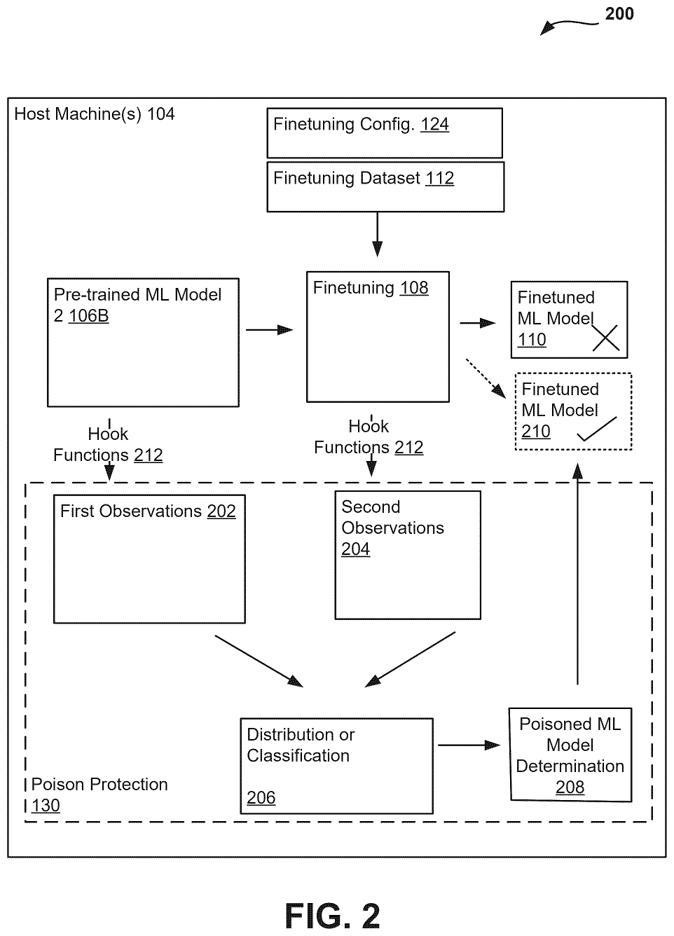

Further, the pre-trained ML models 1 106A-N 106N may be language models, including large language models (LLMs) and may be subject to protection from poisoning by monitoring the finetuning from the third-party. For example, as detailed from at least FIGS. 2-7, the monitoring may be to determine an indication of atypical or unexpected changes in observations during the finetuning. The determination may be a relative to base observations from a base version of the pre-trained ML model being finetuned by the third-party. The finetuning may be performed by third-party users or clients using their remote node.

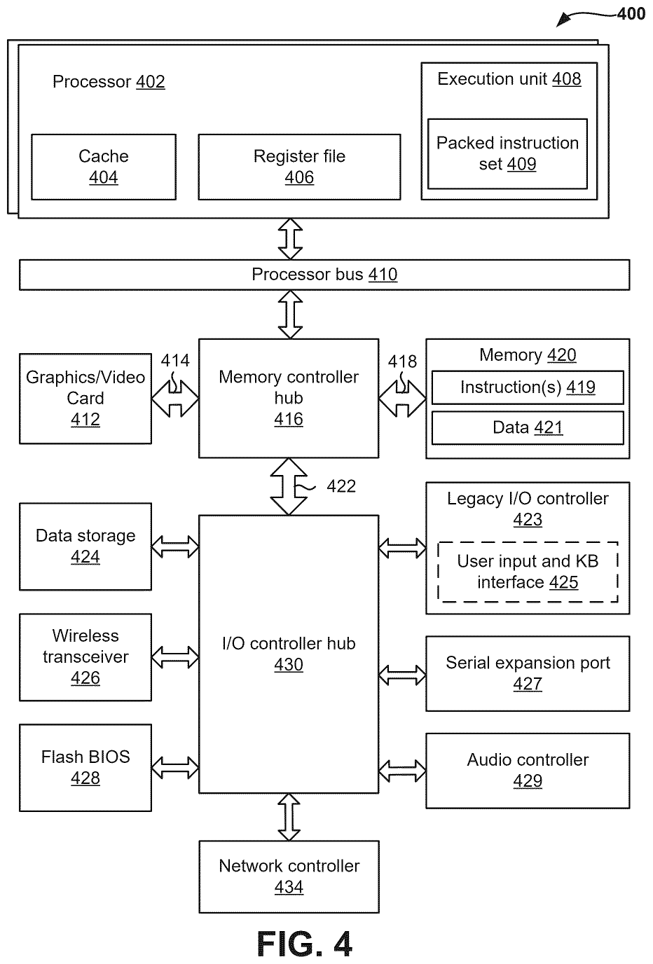

In one example, when the pre-trained ML model is an LLM, observations may be obtained, during finetuning by a third-party, to ensure that the LLM is not being poisoned. The host machine 104 may include one or more central processing units (CPUs), data processing units (DPUs), or graphics processing units (GPUs) to perform aspects of the protection of a pre-trained ML model from poisoning, as described herein. Further, although illustrated in the singular, the host machine 104 may a group of host machines that are to perform aspects of the protection of a pre-trained ML model from poisoning, as described herein. Therefore, FIG. 1 illustrates that the system 100 includes at least a host machine 104 having memory (such as, described with respect to at least FIG. 4) and having at least one processor to execute instructions from the memory to provide pre-trained ML models that are subject to advanced protection from poisoning.

In one example, the host machine 104 may include memory having instructions that are executed by at least one processor of the host machine 104 can obtain first or base observations (such as, one or more of inferences, activations, gradients, or weights) associated with a pre-trained ML model. The first observations may be based in part on correct facts or facts intended for the pre-trained ML model. For example, if the pre-trained ML model is trained to infer recipes using provided ingredients as training input, the pre-trained ML model should not infer harmful or irrelevant information, such as, about chemicals or malicious code, etc. This may be possible poisoning 122 by a malicious entry within a finetuning dataset 112 and/or by improper finetuning configuration 124. In one example, malicious code may be provided in the finetuning dataset 112 to try to bias a pre-trained ML model into providing the malicious code as an inference in response to a query. Similarly, tainting of a recipe in the example of the pre-trained ML model to infer recipes is also a possible outcome of the poisoning during the finetuning of a pre-trained ML model.

The host machine 104 may be caused to obtain second observations during finetuning of the pre-trained ML model at different periods. For example, a hook or hooking function may be used to obtain such second observations. Therefore, while finetuning may be performed by a third-party, with incorrect or biased inputs (such as, poisoned by a trigger attack or a knowledge editing attack to bias the pre-trained ML model or to pass through malicious code), the second observations may be analyzed against the first or base observations. A distribution or classification may be obtained in the analysis. The distribution or classification may be an anomaly detection using distribution statistics or a classification detection using a classifier. A poisoned ML model can be determined based in part on the distribution or classification being different than a predetermined threshold or being outside a predetermined threshold range. For example, there may be expected differences that are acceptable till these differences (in either a distribution or a classification) are outside thresholds. Once outside a threshold or a threshold range, a determination of poisoning of the pre-trained ML model, during finetuning, may be made. In doing so, the poisoning described herein that may include training to introduce vulnerabilities, backdoors, or biases that could compromise a pre-trained ML model's security, effectiveness, or ethical behavior may be discovered and addressed.

In at least one embodiment, while inferences may be used from a teacher model to improve a student model, as part of an ML model development, the protections from poisoning for a pre-trained ML model herein are directed to observations from a pre-trained ML model and from during finetuning of the pre-trained ML model and are directed to determining poisoning, distinct from improvements to a student ML model. Further, instead of inferences, the monitoring herein may to internal (or hidden) states of a pre-trained ML model, such as activations, weights, and gradients, during finetuning, to determine differences in a current state of a pre-trained ML model as against similar internal or hidden states of the same pre-trained ML model that is not subject to finetuning.

As illustrated in FIG. 1, an ML service provider may communicate 114 generation instructions for generating one or more of the pre-trained ML models 1 106A-N 106N. In one example, based in part on communicated 114 generation instructions, the host machine 104 may use a training dataset 120 of different training data suited to different applications to generate the pre-trained ML models. In one example, the training dataset may be available datasets of correct facts or intended facts, from different providers than the ML service provider or may be provided by the ML service provider. In one example of a cooking artificial intelligence (AI) application, the correct facts in a training dataset 120 may be associated with recipes, ingredients, and other food preparation related data to allow for inferences of recipes. The ML service provider may also communicate 114 pre-train input pertaining to pre-train configurations 126 to be used to generate one or more of the pre-trained ML models 1 106A-N 106N. In one example, the pre-train input may be activation functions, initial weights, and initial biases, or may be selections of activation functions, initial weights, and initial biases that may be already in the pre-train configurations 126. The ML service provider may also communicate 114 access control instructions to the host machine 104 to allow a third-party to access, to finetune, and to use, for variations of the applications, one or more of the pre-trained ML models.

Separately, a third-party may use its remote node 116 to communicate 128 model selection instructions to select one pre-trained ML model 2 106B of the available pre-trained ML models 1 106A-N 106N for a third-party application. Further, the third-party may communicate 128 a dataset input and a finetuning input to be used to finetune the one pre-trained ML model 2 106B. While the dataset input might include individual data to be used in the finetuning, it may alternatively include a selection or other input to apply or selection a portion of an existing finetuning dataset 112. Therefore, the finetuning dataset 112 is a provided or selected dataset. In one example, for testing purposes, the third-party may use counterfact datasets, such as FEVER®, CounterFact®, and zsRE®. In one example, as to the pre-trained ML model for food preparation related data to allow for inferences of recipes, the third-party may use this pre-trained ML model with finetuning to inform about allergies. Therefore, instead of general inferences of recipes, a finetuned version of this example pre-trained ML model can provide specific inferences of recipes to suit a user's allergies, for instance.

In at least one embodiment, the finetuning input allows application or selection of finetuning configuration 124 pertaining to updates that can be applied to a pre-trained ML model, such as, to weights, biases, epochs, and other features, during a finetuning process. Further, the finetuning input may be also provided to fix one or more of the weights, biases, or other parameters so that they do not change as a manner of finetuning a pre-trained ML model. In at least one embodiment, all of such communications 114, 128 may be performed via interfaces, such as, one or more APIs authorized by the ML service provider and of the host machine 104 of the system environment 102.

In at least one embodiment, the ML service provider may also communicate 114 a poison protection input to the host machine 104. Part of the access granted by the ML service provider may be to require the third-party to allow monitoring of the finetuning performed by the third-party but that is in shared resources or in resources available or accessible to both the third-party and the ML service provider. A poison protection module 130 to perform the monitoring for poisoning of a pre-trained ML model may be provided in the system environment 102. For example, the poison protection module 130 may include one or more components that may be located in at least the ML service provider's part of the shared resource, with access to or with one or more components on resources of at least the third-party, as described further with respect to FIG. 2. In one example, the components may include hook functions and executable instructions to perform a distribution or a classification of observations obtained using the hook functions.

FIG. 2 illustrates aspects 200 of a pre-trained ML model that incorporates advanced protection from poisoning, according to at least one embodiment. The aspects 200 illustrated may be further details of the system 100 in FIG. 1. For example, the host machine 104 includes memory and at least one processor to execute instructions from the memory to cause the system 100 to obtain first observations 202 associated with a pre-trained ML model that may be selected by a third-party for finetuning. Further, the instructions from the memory can also cause the system 100 to obtain second observations 204 during the finetuning of the same pre-trained ML model by the third-party. In one example, there is a secure sharing arrangement to enable the sharing of such second observations 204 from the third-party to the ML service provider, which also provides the poison protection for its pre-trained ML models. In one example, a poison protection module 130 is able to receive the first and the second observations and is able to perform its analysis on these observations.

In at least one embodiment, the poison protection module 130 may be able to obtain the observations using hook functions 212 that may be user-defined functions within the finetuning process and/or within the pre-trained ML model. The hook functions 212 can receive input, output, or gradients as arguments and can perform any operation to provide these arguments to the poison protection module 130. In at least one embodiment, this provision of the arguments may occur in real-time, substantially real-time, or in different periods as the finetuning progresses for the pre-trained ML model. One or more components 202-208 of the poison protection module 130 may be able to perform monitoring of potential poisoning of the pre-trained ML model as the second observations are received and are fed to a distribution or classification having at least the first observations applied to and trained thereto.

In at least one embodiment, the hook function 212 can function with gradients. For example, the hook function 212 may be activated every time a gradient is activated. The hook function 212 can return, as arguments, an upgraded gradient. In at least one embodiment, it is possible to use the hook function 212 with customization to hook into specific layers or modules within a pre-trained ML model. Therefore, a hook function 212 herein can be used within both the forward and backward passes, during finetuning, of a pre-trained ML model. The ability to access activations, weights, and gradients, during finetuning in both forward and backward passes, enables in-depth verification of possible poisoning 122 that may be occurring during the finetuning. In one example, the hook function 212 may be associated with a driver to communicate with a network interface card (NIC), for instance, to pass on data between modules of the host machine 104. While illustrated in the singular, the reference to a hook function 212 is a reference to one or more hook functions that may be used for a similar goal, which is to obtain second observations 204 for at least the finetuning 108 of a pre-trained ML model.

In one example, a hook function may be registered for a forward pass and a different hook function may be registered for a backward pass, for providing the second observations 204. Then, every time the pre-trained ML model is subject to a finetuning cycle, the hook function may be called for the forward and the backward passes and can return data associated with activations, weights, and gradients mid-pass in the forward or the backward pass. Further, this is beneficial because if there are substantial changes in activations, weights, and gradients or if the changes occur too soon, or if there are large separations or gaps between the changes, in each epoch, for instance, that may be a sign of poisoning on-going during the finetuning.

In at least one embodiment, there may be different types of hook functions in addition to the forward and the backward passes. A third type of hook function may be a pre-forward hook function. The hook function herein may apply to any layer or part of a pre-trained ML model, such as, the entire pre-trained ML model, one of the fully connected layers or one of the convolutional layers. As such, the hook function 212 herein may be used with the pre-trained ML model and during the finetuning of the pre-trained ML model.

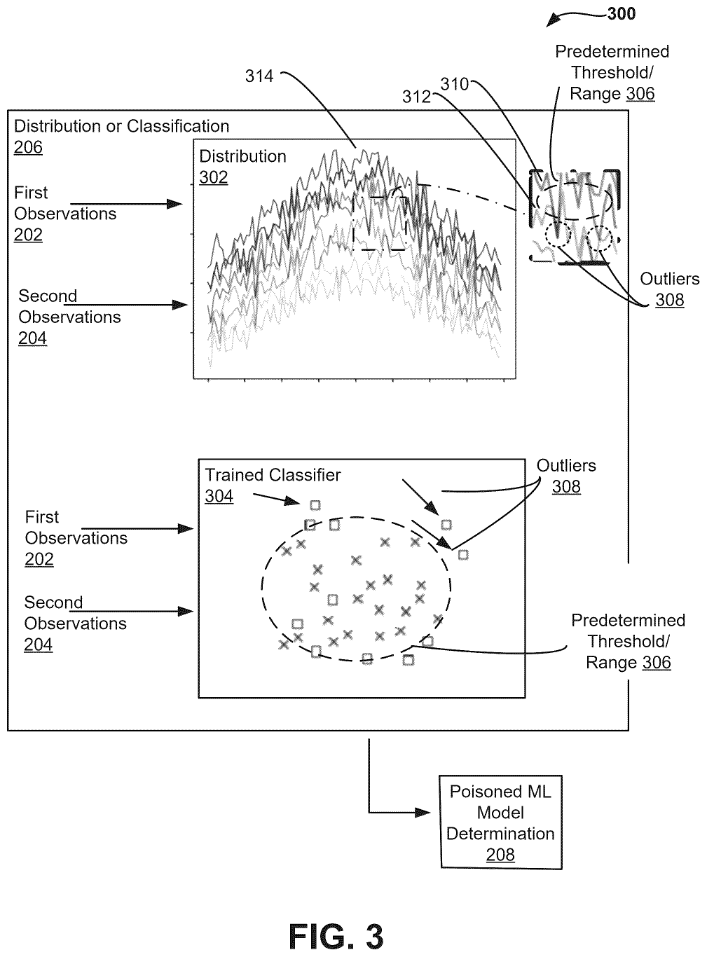

The host machine 104 can further determine a distribution or classification 206 of the first observations 202 from the pre-trained ML model 2 106B that was selected by a third-party, with respect to second observations 204 obtained during finetuning 108 of the pre-trained ML model 2 106B performed by the third-party. Such first and second observations 202, 204 may be obtained at different periods, but at least during training of the pre-trained ML model 2 106B. For instance, during training the second observations 204 may be obtained but sent at a later time. However, for integrity of the process, it is appreciated that the poisoning protection described herein may be effective when determined earlier in the finetuning process. Further, the poison protection module 130 of the host machine 104 can determine 208 a poisoned ML model, based in part on the distribution or classification 206 being different than a predetermined threshold or being outside a predetermined threshold range, as detailed further in reference to at least FIG. 3 herein. For example, the finetuned ML model 110 may not be attested by the ML service provider as a result of the determination that it is a poisoned ML model. However, other finetuned ML models 210 that are determined as consistent with a predetermined threshold or being within a predetermined threshold range can be attested by the ML service provider and used further by the third-party.

In at least one embodiment, the pre-trained ML models herein are language models. Further, the first observations 202 and the second observations 204 may be, respectively, one or more of inferences, activations, gradients, or weights of the pre-trained ML model or from during the finetuning of the pre-trained ML model 2 106B. In the example herein, therefore, the pre-trained ML model may be associated with correct or intended facts, whereas, if the finetuning is associated with poisoning, this may be determined by the poison protection module 130. The finetuning 108 of the pre-trained ML model 2 106B herein may be associated with third-party facts, in the finetuning dataset 112, to change one or more of an inference, an activation, a weight, or a gradient of the pre-trained ML model 2 106B. However, such a change is not to a fundamental purpose of the pre-trained ML model 2 106B.

FIG. 3 illustrates aspects 300 of a distribution or classification 206 with respect to a predetermined threshold or a predetermined threshold range, according to at least one embodiment. In one example, the distribution 302 of the distribution or classification 206 may be a statistical measure that is of one or more of a combination of Gaussians, a mean of individual ones of the Gaussians, or an approximated covariance of individual ones of the Gaussians. In one example, the first and second observations 202, 204 having one or more of an inference, an activation, a weight, or a gradient may be provided as input to a distribution or classification 206 module performed on the host machine 104.

In the case of base or first observations 202 that are normal data from a pre-trained ML model 2 106B, there may be an eventual single-peaked distributions 314 pertaining to the different features of inferences, activations, weights, or gradients. Further, for anomaly data, a higher probability density in the distribution 302 may be an indication of normalcy. However, as the pre-trained ML model 2 106B is subject to finetuning, the distribution 302 may include irregularity that is also normal. Such irregularity may be changes to density but many need to be monitored over a period to prevent reliance on local minima or maxima. In at least one example, the distribution 302 may be multi-peaked distribution of varying peak values. As such, a probability density associated with the distribution 302 may not be positively correlated with normalcy but can be resolved by use of predetermined threshold and/or range 306 from base observations. The predetermined threshold and/or range 306 may be applied to a combination of Gaussians, a mean of individual ones of the Gaussians, or an approximated covariance of individual ones of the Gaussians.

In at least one embodiment, a combination of Gaussians may be a based in part on a Gaussian Mixture Model (GMM). In the GMM, the base or first observations 202 may be provided as one plot 312 of the plots within the distribution 302, along with the second observations 204 as another plot 310 of the plots within the distribution 302. Further, while illustrated as plots, these are merely for illustrative purposes and the distribution 302 may be performed by the host machine without providing the illustrations. The provided plots within the distribution 302 may studied for their probability density function (PDF) values. The PDF values may be used to define, in part, the predetermined threshold and/or range 306 for the distribution 302. Thereafter, inconsistencies in the PDF values may be used to determine outliers 308 or anomaly events, reflecting a determination 208 of a poisoned ML model that is determined based in part on the distribution 302. The predetermined threshold and/or range 306 can be used to determine sufficiency of the second observations within a class of the first observations, in one example.

In one example, the predetermined threshold and/or range 306 may be based in part on raw data in the training dataset 120 that was used in the pre-training ML model. The predetermined threshold and/or range 306 may be determined using an amount of the raw data, such as, 50% of the raw data having higher yields than the intended PDF values, implying a median selection in the distribution 302, but may also be determined using a confidence in the distribution 302. Therefore, the distribution 302 may include a median selection to represent a combination of Gaussians, but may include a mean of individual ones of the Gaussians or an approximated covariance of individual ones of the Gaussians. In one example, a predetermined threshold and/or range 306 may be such that it includes a proportion of a total probability mass. However, in all such cases, the PDF values may be based in part on a mixed Gaussian model with multiple ones of the observations providing the components therein. In at least one embodiment, therefore, the predetermined threshold and/or range 306 may be applied to the statistical measure in the distribution 302.

For example, the finetuning should be such that inferences, activations, weights, or gradients can be as expected and within a same distribution. An outlier or multiple outliers 308 may indicate otherwise. Therefore, as illustrated and described with respect to the broken line within the distribution 302, the predetermined threshold and/or threshold range 306 may be applied to at least one part of the different distributions. For example, although the distribution 302 may be as expected for a predetermined ML model, the distribution may be extended by the predetermined threshold and/or threshold range 306 to allow for finetuning-based differences in the second observations, for instance.

As such, the distribution 302 can be provided with the observations of the pre-trained ML model and during the finetuning of the pre-trained ML model. The first and second observations 202, 204 may be inferences, activations, weights, or gradients of both versions of the pre-trained ML model, with the predetermined threshold or the predetermined threshold range applied therein. The distribution 302 can be used to discriminate the poisoned ML model from the pre-trained ML model based in part on outliers 308 in the distribution 302.

In an alternative approach, the host machine 104 herein is also able to perform classification for the poisoned ML model determination 208. For example, the host machine 104 may be caused to perform a trained classifier 304. The trained classifier 304 may be trained using features of the pre-trained ML model and finetuned features during the finetuning of the pre-trained ML model. For example, the first observations 202 and the second observations 204 may be inferences, activations, gradients, or weights. Two or more of the inferences, activations, gradients, or weights may be the features of the pre-trained ML model and the finetuned features. Then, two of or more of such features can enable at least one class for a predetermined threshold and/or range 306, when plotted in two dimensions.

The trained classifier 304 can be used to discriminate the poisoned ML model using outliers 308, from the pre-trained ML model. This may be based in part on different classifications (including being outside a class) of the features and the finetuned features. For example, the finetuning should be such that inferences, activations, weights, or gradients can be as expected and within a same class. An outlier or multiple outliers 308 may indicate otherwise. Therefore, as illustrated and described with respect to the broken line within the trained classifier 304, the predetermined threshold and/or threshold range 306 may be applied to at least one classification of the different classifications. For example, although the class may be as expected for a predetermined ML model, the class may have a decision boundary that may be extended by the predetermined threshold and/or threshold range 306 to allow for finetuning-based differences in the second observations, for instance.

As such, the trained classifier 304 can be trained using features of the pre-trained ML model and finetuned features during the finetuning of the pre-trained ML model. The features may be inferences, activations, weights, or gradients of both versions of the pre-trained ML model, with the predetermined threshold or the predetermined threshold range applied to at least one classification of the classifier. The trained classifier 304 can be used to discriminate the poisoned ML model from the pre-trained ML model based in part on outliers 308 from at least one classification of the features and the finetuned features.

In at least one embodiment, a poisoned ML model herein may be a result of poisoning by one or more of a trigger attack on dataset or a knowledge editing attack of the training dataset 120. The trigger attack or the knowledge editing attack may provide changes to inferences, activations, gradients, or weights of the pre-trained ML model. Further, the host machine 104 herein may cause at least the second observations 204 to be obtained using one or more hooking functions 212 during the finetuning of the pre-trained ML model and may feed these second observations to the trained classifier 304 that has been trained using the first observations 202. The trained classifier 304 may be trained at an earlier time using the first observations, than the classification performed using the second observations.

FIG. 4 illustrates computer and processor aspects 400 of a system for use with a pre-trained ML model that is subject to advanced protection from poisoning, according to at least one embodiment. The computer and processor aspects 400 may be performed by one or more processors that include a system-on-a-chip (SOC) or some combination thereof formed with a processor that may include execution units to execute an instruction, according to at least one embodiment. Such one or more processors may include CPUs, data processing units (DPUs), and graphics processing units (GPUs) and may be within a host machine 104 or any of the remote nodes 116, 118 that support at least some aspects of the system 100 for providing the advanced protection from poisoning in pre-trained ML models, as described all throughout herein.

In at least one embodiment, the computer and processor aspects 400 may include, without limitation, a component, such as a processor 402 to employ execution units including logic to perform algorithms for processing data, in accordance with present disclosure, such as in embodiment described herein. In at least one embodiment, the computer and processor aspects 400 may include processors, such as PENTIUM® Processor family, Xeon™, Itanium®, XScale™ and/or StrongARM™, Intel® Core™, or Intel® Nervana™ microprocessors available from Intel Corporation of Santa Clara, California, although other systems (including PCs having other microprocessors, engineering workstations, set-top boxes and like) may also be used. In at least one embodiment, the computer and processor aspects 400 may execute a version of WINDOWS® operating system available from Microsoft® Corporation of Redmond, Wash., although other operating systems (UNIX® and Linux®, for example), embedded software, and/or graphical user interfaces, may also be used.

Embodiments may be used in other devices such as handheld devices and embedded applications. Some examples of handheld devices include cellular phones, Internet Protocol devices, digital cameras, personal digital assistants (“PDAs”), and handheld PCs. In at least one embodiment, embedded applications may include a microcontroller, a digital signal processor (“DSP”), system on a chip, network computers (“NetPCs”), set-top boxes, network hubs, wide area network (“WAN”) switches, or any other system that may perform one or more instructions in accordance with at least one embodiment.

In at least one embodiment, the computer and processor aspects 400 may include, without limitation, a processor 402 that may include, without limitation, one or more execution units 408 to perform aspects according to techniques described with respect to at least one or more of FIGS. 1-3 and 5-7 herein. In at least one embodiment, the computer and processor aspects 400 is a single processor desktop or server system, but in another embodiment, the computer and processor aspects 400 may be a multiprocessor system.

In at least one embodiment, the processor 402 may include, without limitation, a complex instruction set computer (“CISC”) microprocessor, a reduced instruction set computing (“RISC”) microprocessor, a very long instruction word (“VLIW”) microprocessor, a processor implementing a combination of instruction sets, or any other processor device, such as a digital signal processor, for example. In at least one embodiment, a processor 402 may be coupled to a processor bus 410 that may transmit data signals between processor 402 and other components in computer and processor aspects 400.

In at least one embodiment, a processor 402 may include, without limitation, a Level 1 (“L1”) internal cache memory (“cache”) 404. In at least one embodiment, a processor 402 may have a single internal cache or multiple levels of internal cache. In at least one embodiment, cache 404 may reside external to a processor 402. Other embodiments may also include a combination of both internal and external caches depending on particular implementation and needs. In at least one embodiment, a register file 406 may store different types of data in various registers including, without limitation, integer registers, floating point registers, status registers, and an instruction pointer register.

In at least one embodiment, an execution unit 408, including, without limitation, logic to perform integer and floating point operations, also resides in a processor 402. In at least one embodiment, a processor 402 may also include a microcode (“ucode”) read only memory (“ROM”) that stores microcode for certain macro instructions. In at least one embodiment, an execution unit 408 may include logic to handle a packed instruction set 409.

In at least one embodiment, by including a packed instruction set 409 in an instruction set of a general-purpose processor, along with associated circuitry to execute instructions, operations used by many multimedia applications may be performed using packed data in a processor 402. In at least one embodiment, many multimedia applications may be accelerated and executed more efficiently by using a full width of a processor's data bus for performing operations on packed data, which may eliminate a need to transfer smaller units of data across that processor's data bus to perform one or more operations one data element at a time.

In at least one embodiment, an execution unit 408 may also be used in microcontrollers, embedded processors, graphics devices, DSPs, and other types of logic circuits. In at least one embodiment, the computer and processor aspects 400 may include, without limitation, a memory 420. In at least one embodiment, a memory 420 may be a Dynamic Random Access Memory (“DRAM”) device, a Static Random Access Memory (“SRAM”) device, a flash memory device, or another memory device. In at least one embodiment, a memory 420 may store instruction(s) 419 and/or data 421 represented by data signals that may be executed by a processor 402.

In at least one embodiment, a system logic chip may be coupled to a processor bus 410 and a memory 420. In at least one embodiment, a system logic chip may include, without limitation, a memory controller hub (“MCH”) 416, and processor 402 may communicate with MCH 416 via processor bus 410. In at least one embodiment, an MCH 416 may provide a high bandwidth memory path 418 to a memory 420 for instruction and data storage and for storage of graphics commands, data and textures. In at least one embodiment, an MCH 416 may direct data signals between a processor 402, a memory 420, and other components in the computer and processor aspects 400 and to bridge data signals between a processor bus 410, a memory 420, and a system I/O interface 422. In at least one embodiment, a system logic chip may provide a graphics port for coupling to a graphics controller. In at least one embodiment, an MCH 416 may be coupled to a memory 420 through a high bandwidth memory path 418 and a graphics/video card 412 may be coupled to an MCH 416 through an Accelerated Graphics Port (“AGP”) interconnect 414.

In at least one embodiment, the computer and processor aspects 400 may use a system I/O interface 422 as a proprietary hub interface bus to couple an MCH 416 to an I/O controller hub (“ICH”) 430. In at least one embodiment, an ICH 430 may provide direct connections to some I/O devices via a local I/O bus. In at least one embodiment, a local I/O bus may include, without limitation, a high-speed I/O bus for connecting peripherals to a memory 420, a chipset, and processor 402. Examples may include, without limitation, an audio controller 429, a firmware hub (“flash BIOS”) 428, a wireless transceiver 426, a data storage 424, a legacy I/O controller 423 containing user input and keyboard interfaces 425, a serial expansion port 427, such as a Universal Serial Bus (“USB”) port, and a network controller 434. In at least one embodiment, data storage 424 may comprise a hard disk drive, a floppy disk drive, a CD-ROM device, a flash memory device, or other mass storage device.

In at least one embodiment, FIG. 4 illustrates computer and processor aspects 400, which includes interconnected hardware devices or “chips”, whereas in other embodiments, FIG. 4 may illustrate an exemplary SoC. In at least one embodiment, devices illustrated in FIG. 4 may be interconnected with proprietary interconnects, standardized interconnects (e.g., PCIe®) or some combination thereof. In at least one embodiment, one or more components of the computer and processor aspects 400 that are interconnected using compute express link (CXL) interconnects.

In at least one embodiment, the system in FIGS. 1-4 includes one or more execution units 408 for a host machine 104 to support advanced protection from poisoning for pre-trained ML models. The at least one execution unit 408 is part of one or more circuits which are to be associated with the host machine 104 and/or with a remote node 116, 118 in a system 100. For example, the at least one execution unit 408 of a processor may be a circuit that is to be part of a host machine 104 with another circuit of another processor in the same or a different host machine or in one or more of the remote nodes.

In one example, therefore, such one or more circuits can obtain first observations associated with a pre-trained machine learning (ML) model. The one or more circuits can also determine a distribution or classification of the first observations with respect to second observations obtained during finetuning of the pre-trained ML model at different periods. Further, the one or more circuits performing the distribution or classification can determine a poisoned ML model based in part on the distribution or classification being different than a predetermined threshold or being outside a predetermined threshold range.

In addition, the one or more circuits herein support finetuning of the pre-trained ML model by a third-party using third-party facts in a finetuning database. However, the third-party may not be aware of poisoning in its finetuning database, and such poisoning may be also determined and informed to the third-party. In one example, the finetuning may be to change one or more of an inference, an activation, a weight, or a gradient of the pre-trained ML model. In at least one embodiment, the one or more circuits in FIG. 4 is such that the distribution associated with the first and the second observations is a statistical measure of one or more of a combination of Gaussians, a mean of individual ones of the Gaussians, or an approximated covariance of individual ones of the Gaussians. The predetermined threshold or the predetermined threshold range, as such, may be applied to the statistical measure, as described with respect to FIG. 3.

The one or more circuits may be associated with instructions that, when executed by the at least one processor, cause the one or more circuits to perform advanced protection from poisoning for a pre-trained ML model. In at least one embodiment, the one or more circuits in FIG. 4 is such that the first and the second observations are used with a classifier which is trained using features of the pre-trained ML model and using finetuned features during the finetuning of the pre-trained ML model. In one example, the features of the pre-trained ML model and the finetuned features may be an inference, an activation, a weight, or a gradient. The classifier may be used to discriminate the poisoned ML model from the pre-trained ML model. This may be based in part on different classifications of the features and the finetuned features. The predetermined threshold or the predetermined threshold range may be applied to at least one of the different classifications, as described with respect to FIG. 3.

The one or more circuits herein can be used to determine the poisoned ML model which may be poisoned by one or more of a trigger attack on dataset or a knowledge editing attack of the dataset. The trigger attack or the knowledge editing attack may provide changes to inferences, activations, gradients, or weights of the pre-trained ML model, which may be determined by the advanced protection from poisoning for a pre-trained ML model, detailed herein. Further, the one or more circuits may perform instructions by execution in at least one processor further to cause at least the second observations to be obtained using one or more hooking functions during the finetuning of the pre-trained ML model.

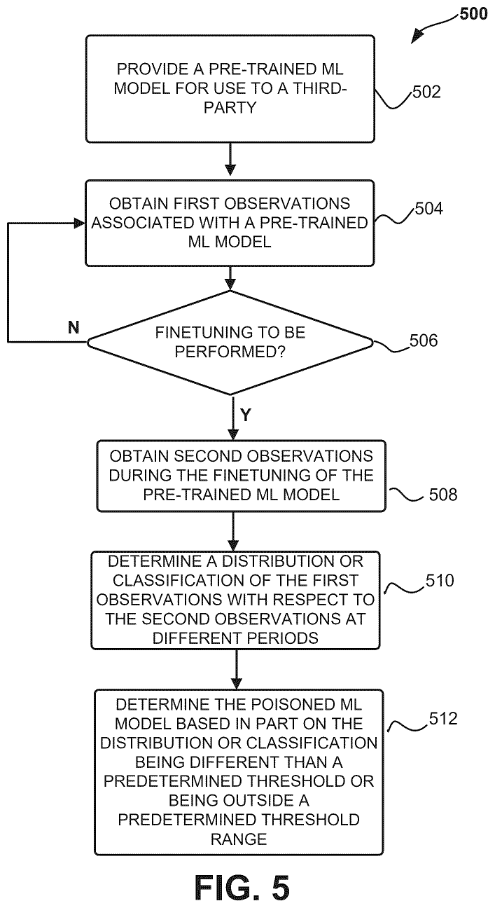

FIG. 5 illustrates a process flow or method 500 in a system for a pre-trained ML model that is subject to advanced protection from poisoning, according to at least one embodiment. The method 500 may include providing 502 a pre-trained ML model for use to a third-party. The method 500 may include obtaining 504 first observations associated with a pre-trained ML model. This may be performed by one or more hook functions, for instance. The method 500 may include verifying or determining 506 that the third-party is to perform finetuning with the pre-trained ML model. The method 500 may include obtaining 508 second observations during the finetuning of the pre-trained ML model. This too may be performed using one or more hook functions during the finetuning of the pre-trained ML model. There may be one or more APIs to allow the third-party to share the second observations during the finetuning, in one example.

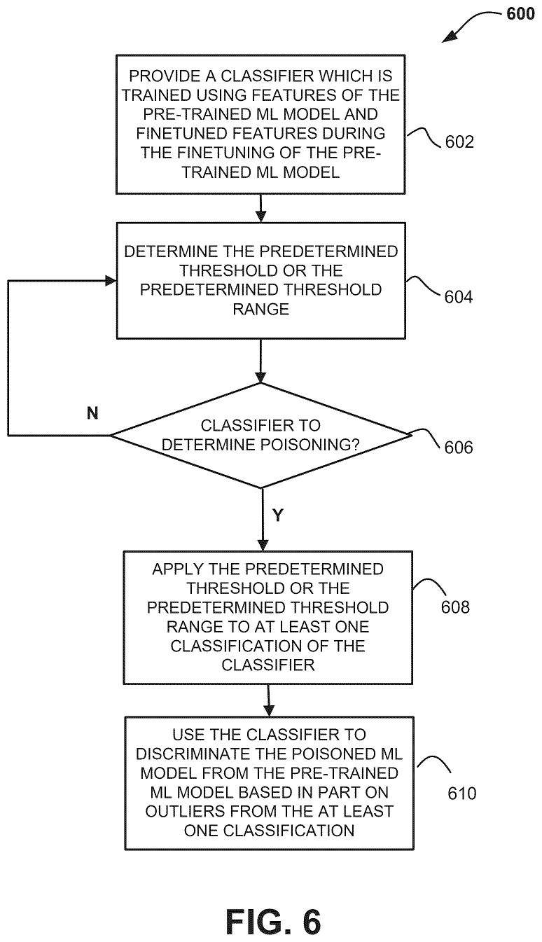

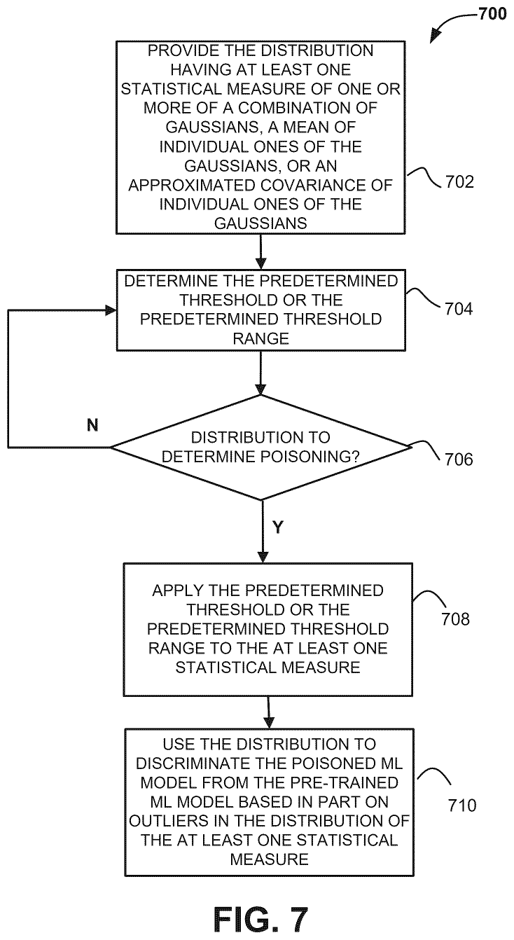

The method 500 may include determining 510 a distribution or classification of the first observations with respect to the second observations at different periods. In one example, this may be performed by further features described with respect to FIGS. 6 and 7 herein and already described with one or more of FIGS. 1-4 herein. The intent is to ensure similar distribution or classification of the first observations with respect to the second observations at different periods. In particular, the hook functions allow observations during one or more hidden states of a pre-trained ML model, as well as during finetuning of the pre-trained ML model, without accessing the data used in the finetuning. These observations may be monitored by the features in FIG. 5.

The method 500 may include determining 512 the poisoned ML model based in part on the distribution or classification being different than a predetermined threshold or being outside a predetermined threshold range. As the intent to ensure similarity, the similarity may be objectively characterized by application of a predetermined threshold or a predetermined threshold range to the distribution or classification. The predetermined threshold and/or range may be determined using an amount of raw data, such as, 50% of the training data for the base version of the pre-trained ML model, while ensuring that such 50% of the training data includes higher yields than intended PDF values in a Gaussian mixture model. However, other statistical measures may be used with the distribution. A predetermined threshold and/or range for a classification may be such that it includes a majority percentage of possible outliers, in one example.

FIG. 6 illustrates yet another process flow or method 600 in a system for a pre-trained ML model that is subject to advanced protection from poisoning, according to at least one embodiment. The method 600 may be in support of the method 500 in FIG. 5. For example, the method 600 details the classification aspect of step 510 in the method 500 of FIG. 5. The method 600 in FIG. 6 may include providing 602 a classifier which is trained using features of the pre-trained ML model and finetuned features during the finetuning of the pre-trained ML model. The method 600 may include determining 604 the predetermined threshold or the predetermined threshold range, as suited to a classifier. The method 600 may include verifying or determining 606 that the classifier is to be used to determine poisoning.

In at least one embodiment, the method 600 may include applying 608 the predetermined threshold or the predetermined threshold range to at least one classification of the classifier. As described with respect to at least FIG. 5, the predetermined threshold and/or range for a classification may be such that it includes a majority percentage of possible outliers, in one example. For example, a decision boundary may be generated to incorporate a center or some feature of the first observations and a percentage extension from the center or the feature determined for the decision boundary. In one example, a decision boundary for a class may be as required to encompass features for a predetermined ML model and may be extended by the predetermined threshold or threshold range to allow for finetuning-based differences in the second observations, for instance. The method 600 may include using 610 the classifier to discriminate the poisoned ML model from the pre-trained ML model based in part on outliers from the at least one classification.

FIG. 7 illustrates a further process flow or method 700 in a system for autonomous discovery of peer nodes using secrets, according to at least one embodiment. The method 700 may be in support of one or more of the method 500 in FIG. 5 or the method 600 in FIG. 6. For example, the method 700 details the distribution aspect of step 510 in the method 500 of FIG. 5. The method 700 in FIG. 7 may include providing 702 the distribution having at least one statistical measure of one or more of a combination of Gaussians, a mean of individual ones of the Gaussians, or an approximated covariance of individual ones of the Gaussians.

The method 700 may include determining 704 the predetermined threshold or the predetermined threshold range. The method 700 may include verifying or determining 706 that the distribution is to be used to determine poisoning of a pre-trained ML model. The method 700 may include applying 708 the predetermined threshold or the predetermined threshold range to the at least one statistical measure. For example, although the distribution may be as expected for a predetermined ML model, the distribution may be extended by the predetermined threshold or threshold range to allow for finetuning-based differences in the second observations, for instance. The method 700 may include using 710 the distribution to discriminate the poisoned ML model from the pre-trained ML model based in part on outliers in the distribution of the at least one statistical measure.

Further, one or more of the methods 500-700 herein may be such that the first observations and the second observations are, respectively, one or more of inferences, activations, gradients, or weights of the pre-trained ML model or from during the finetuning of the pre-trained ML model. In addition, one or more of the methods 500-700 herein may be such that the distribution is a statistical measure of one or more of a combination of Gaussians, a mean of individual ones of the Gaussians, or an approximated covariance of individual ones of the Gaussians. The predetermined threshold or the predetermined threshold range may then be applied to the statistical measure and used to determine the poisoning of the pre-trained ML model.

Other variations are within spirit of present disclosure. Thus, while disclosed techniques are susceptible to various modifications and alternative constructions, certain illustrated embodiments thereof are shown in drawings and have been described above in detail. It should be understood, however, that there is no intention to limit disclosure to specific form or forms disclosed, but on contrary, intention is to cover all modifications, alternative constructions, and equivalents falling within spirit and scope of disclosure, as defined in appended claims.

Use of terms “a” and “an” and “the” and similar referents in context of describing disclosed embodiments (especially in context of following claims) are to be construed to cover both singular and plural, unless otherwise indicated herein or clearly contradicted by context, and not as a definition of a term. Terms “comprising,” “having,” “including,” and “containing” are to be construed as open-ended terms (meaning “including, but not limited to,”) unless otherwise noted. “Connected,” when unmodified and referring to physical connections, is to be construed as partly or wholly contained within, attached to, or joined together, even if there is something intervening. Recitation of ranges of values herein are merely intended to serve as a shorthand method of referring individually to each separate value falling within range, unless otherwise indicated herein and each separate value is incorporated into specification as if it were individually recited herein. In at least one embodiment, use of term “set” (e.g., “a set of items”) or “subset” unless otherwise noted or contradicted by context, is to be construed as a nonempty collection comprising one or more members. Further, unless otherwise noted or contradicted by context, term “subset” of a corresponding set does not necessarily denote a proper subset of corresponding set, but subset and corresponding set may be equal.

Conjunctive language, such as phrases of form “at least one of A, B, and C,” or “at least one of A, B and C,” unless specifically stated otherwise or otherwise clearly contradicted by context, is otherwise understood with context as used in general to present that an item, term, etc., may be either A or B or C, or any nonempty subset of set of A and B and C. For instance, in illustrative example of a set having three members, conjunctive phrases “at least one of A, B, and C” and “at least one of A, B and C” refer to any of following sets: {A}, {B}, {C}, {A, B}, {A, C}, {B, C}, {A, B, C}. Thus, such conjunctive language is not generally intended to imply that certain embodiments require at least one of A, at least one of B and at least one of C each to be present. In addition, unless otherwise noted or contradicted by context, term “plurality” indicates a state of being plural (e.g., “a plurality of items” indicates multiple items). In at least one embodiment, number of items in a plurality is at least two, but can be more when so indicated either explicitly or by context. Further, unless stated otherwise or otherwise clear from context, phrase “based on” means “based at least in part on” and not “based solely on.”

Operations of processes described herein can be performed in any suitable order unless otherwise indicated herein or otherwise clearly contradicted by context. In at least one embodiment, a process such as those processes described herein (or variations and/or combinations thereof) is performed under control of one or more computer systems configured with executable instructions and is implemented as code (e.g., executable instructions, one or more computer programs or one or more applications) executing collectively on one or more processors, by hardware or combinations thereof. In at least one embodiment, code is stored on a computer-readable storage medium, for example, in form of a computer program comprising a plurality of instructions executable by one or more processors.

In at least one embodiment, a computer-readable storage medium is a non-transitory computer-readable storage medium that excludes transitory signals (e.g., a propagating transient electric or electromagnetic transmission) but includes non-transitory data storage circuitry (e.g., buffers, cache, and queues) within transceivers of transitory signals. In at least one embodiment, code (e.g., executable code or source code) is stored on a set of one or more non-transitory computer-readable storage media having stored thereon executable instructions (or other memory to store executable instructions) that, when executed (i.e., as a result of being executed) by one or more processors of a computer system, cause computer system to perform operations described herein. In at least one embodiment, set of non-transitory computer-readable storage media comprises multiple non-transitory computer-readable storage media and one or more of individual non-transitory storage media of multiple non-transitory computer-readable storage media lack all of code while multiple non-transitory computer-readable storage media collectively store all of code. In at least one embodiment, executable instructions are executed such that different instructions are executed by different processors for example, a non-transitory computer-readable storage medium store instructions and a main central processing unit (“CPU”) executes some of instructions while a graphics processing unit (“GPU”) executes other instructions. In at least one embodiment, different components of a computer system have separate processors and different processors execute different subsets of instructions.

In at least one embodiment, an arithmetic logic unit is a set of combinational logic circuitry that takes one or more inputs to produce a result. In at least one embodiment, an arithmetic logic unit is used by a processor to implement mathematical operation such as addition, subtraction, or multiplication. In at least one embodiment, an arithmetic logic unit is used to implement logical operations such as logical AND/OR or XOR. In at least one embodiment, an arithmetic logic unit is stateless, and made from physical switching components such as semiconductor transistors arranged to form logical gates. In at least one embodiment, an arithmetic logic unit may operate internally as a stateful logic circuit with an associated clock. In at least one embodiment, an arithmetic logic unit may be constructed as an asynchronous logic circuit with an internal state not maintained in an associated register set. In at least one embodiment, an arithmetic logic unit is used by a processor to combine operands stored in one or more registers of the processor and produce an output that can be stored by the processor in another register or a memory location.

In at least one embodiment, as a result of processing an instruction retrieved by the processor, the processor presents one or more inputs or operands to an arithmetic logic unit, causing the arithmetic logic unit to produce a result based at least in part on an instruction code provided to inputs of the arithmetic logic unit. In at least one embodiment, the instruction codes provided by the processor to the ALU are based at least in part on the instruction executed by the processor. In at least one embodiment combinational logic in the ALU processes the inputs and produces an output which is placed on a bus within the processor. In at least one embodiment, the processor selects a destination register, memory location, output device, or output storage location on the output bus so that clocking the processor causes the results produced by the ALU to be sent to the desired location.

Accordingly, in at least one embodiment, computer systems are configured to implement one or more services that singly or collectively perform operations of processes described herein and such computer systems are configured with applicable hardware and/or software that allow performance of operations. Further, a computer system that implements at least one embodiment of present disclosure is a single device and, in another embodiment, is a distributed computer system comprising multiple devices that operate differently such that distributed computer system performs operations described herein and such that a single device does not perform all operations.

Use of any and all examples, or exemplary language (e.g., “such as”) provided herein, is intended merely to better illuminate embodiments of disclosure and does not pose a limitation on scope of disclosure unless otherwise claimed. No language in specification should be construed as indicating any non-claimed element as essential to practice of disclosure.

In description and claims, terms “coupled” and “connected,” along with their derivatives, may be used. It should be understood that these terms may be not intended as synonyms for each other. Rather, in particular examples, “connected” or “coupled” may be used to indicate that two or more elements are in direct or indirect physical or electrical contact with each other. “Coupled” may also mean that two or more elements are not in direct contact with each other, but yet still co-operate or interact with each other.

Unless specifically stated otherwise, it may be appreciated that throughout specification terms such as “processing,” “computing,” “calculating,” “determining,” or like, refer to action and/or processes of a computer or computing system, or similar electronic computing device, that manipulate and/or transform data represented as physical, such as electronic, quantities within computing system's registers and/or memories into other data similarly represented as physical quantities within computing system's memories, registers or other such information storage, transmission or display devices.

In a similar manner, term “processor” may refer to any device or portion of a device that processes electronic data from registers and/or memory and transform that electronic data into other electronic data that may be stored in registers and/or memory. As non-limiting examples, “processor” may be a CPU or a GPU. A “computing platform” may comprise one or more processors. As used herein, “software” processes may include, for example, software and/or hardware entities that perform work over time, such as tasks, threads, and intelligent agents. Also, each process may refer to multiple processes, for carrying out instructions in sequence or in parallel, continuously or intermittently. In at least one embodiment, terms “system” and “method” are used herein interchangeably insofar as system may embody one or more methods and methods may be considered a system.

In present document, references may be made to obtaining, acquiring, receiving, or inputting analog or digital data into a subsystem, computer system, or computer-implemented machine. In at least one embodiment, process of obtaining, acquiring, receiving, or inputting analog and digital data can be accomplished in a variety of ways such as by receiving data as a parameter of a function call or a call to an application programming interface. In at least one embodiment, processes of obtaining, acquiring, receiving, or inputting analog or digital data can be accomplished by transferring data via a serial or parallel interface. In at least one embodiment, processes of obtaining, acquiring, receiving, or inputting analog or digital data can be accomplished by transferring data via a computer network from providing entity to acquiring entity. References may also be made to providing, outputting, transmitting, sending, or presenting analog or digital data. In at least one embodiment, processes of providing, outputting, transmitting, sending, or presenting analog or digital data can be accomplished by transferring data as an input or output parameter of a function call, a parameter of an application programming interface or interprocess communication mechanism.

Although descriptions herein set forth example implementations of described techniques, other architectures may be used to implement described functionality, and are intended to be within scope of this disclosure. Furthermore, although specific distributions of responsibilities may be defined above for purposes of description, various functions and responsibilities might be distributed and divided in different ways, depending on circumstances.

Furthermore, although subject matter has been described in language specific to structural features and/or methodological acts, it is to be understood that subject matter claimed in appended claims is not necessarily limited to specific features or acts described. Rather, specific features and acts are disclosed as exemplary forms of implementing the claims.

What is claimed is:

1. A system comprising memory and at least one processor to execute instructions from the memory to cause the system to obtain first observations associated with a pre-trained ML model, wherein the system is further to determine a distribution or classification of the first observations with respect to second observations obtained during finetuning of the pre-trained ML model at different periods, and wherein a poisoned ML model is determined based in part on the distribution or classification being different than a predetermined threshold or being outside a predetermined threshold range.

2. The system of claim 1, wherein the pre-trained ML model is language model.

3. The system of claim 1, wherein the first observations and the second observations are, respectively, one or more of inferences, activations, gradients, or weights of the pre-trained ML model or from during the finetuning of the pre-trained ML model.

4. The system of claim 1, wherein the pre-trained ML model is associated with intended facts.

5. The system of claim 1, wherein finetuning of the pre-trained ML model is associated with third-party facts to change one or more of an inference, an activation, a weight, or a gradient of the pre-trained ML model.

6. The system of claim 1, wherein the distribution comprises at least one statistical measure of one or more of a combination of Gaussians, a mean of individual ones of the Gaussians, or an approximated covariance of individual ones of the Gaussians, wherein the predetermined threshold or the predetermined threshold range is applied to the at least one statistical measure and wherein the distribution is to discriminate the poisoned ML model from the pre-trained ML model based in part on outliers in the distribution of the at least one statistical measure.

7. The system of claim 1, wherein the instructions when executed by the at least one processor further cause a classifier which is trained using features of the pre-trained ML model and finetuned features during the finetuning of the pre-trained ML model, wherein the predetermined threshold or the predetermined threshold range is applied to at least one classification of the classifier, and wherein the classifier is used to discriminate the poisoned ML model from the pre-trained ML model based in part on outliers from at least one classification of the features and the finetuned features.

8. The system of claim 1, wherein the poisoned ML model is poisoned by one or more of a trigger attack on dataset or a knowledge editing attack of the dataset, and wherein the trigger attack or the knowledge editing attack provide changes to inferences, activations, gradients, or weights of the pre-trained ML model.

9. The system of claim 1, wherein the instructions when executed by the at least one processor further cause at least the second observations to be obtained using one or more hooking functions during the finetuning of the pre-trained ML model.

10. One or more circuits to obtain first observations associated with a pre-trained machine learning (ML) model, wherein the one or more circuits is further to determine a distribution or classification of the first observations with respect to second observations obtained during finetuning of the pre-trained ML model at different periods, and wherein a poisoned ML model is determined based in part on the distribution or classification being different than a predetermined threshold or being outside a predetermined threshold range.

11. The one or more circuits of claim 10, wherein finetuning of the pre-trained ML model is associated with third-party facts to change one or more of an inference, an activation, a weight, or a gradient of the pre-trained ML model.

12. The one or more circuits of claim 10, wherein the distribution comprises at least one statistical measure of one or more of a combination of Gaussians, a mean of individual ones of the Gaussians, or an approximated covariance of individual ones of the Gaussians, wherein the predetermined threshold or the predetermined threshold range is applied to the at least one statistical measure and wherein the distribution is to discriminate the poisoned ML model from the pre-trained ML model based in part on outliers in the distribution of the at least one statistical measure.

13. The one or more circuits of claim 10, wherein the instructions when executed by the at least one processor further cause a classifier which is trained using features of the pre-trained ML model and finetuned features during the finetuning of the pre-trained ML model, wherein the predetermined threshold or the predetermined threshold range is applied to at least one classification of the classifier, and wherein the classifier is used to discriminate the poisoned ML model from the pre-trained ML model based in part on outliers from at least one classification of the features and the finetuned features.

14. The one or more circuits of claim 10, wherein the poisoned ML model is poisoned by one or more of a trigger attack on dataset or a knowledge editing attack of the dataset, and wherein the trigger attack or the knowledge editing attack provide changes to inferences, activations, gradients, or weights of the pre-trained ML model.

15. The one or more circuits of claim 10, wherein the instructions when executed by the at least one processor further cause at least the second observations to be obtained using one or more hooking functions during the finetuning of the pre-trained ML model.

16. A method for determining a poisoned machine learning (ML) model, comprising:
providing a pre-trained ML model for finetuning to a third-party;
obtaining first observations associated with a pre-trained ML model;
obtaining second observations during the finetuning of the pre-trained ML model;
determining a distribution or classification of the first observations with respect to second observations at different periods; and
determining the poisoned ML model based in part on the distribution or classification being different than a predetermined threshold or being outside a predetermined threshold range.

17. The method of claim 16, wherein the distribution is a statistical measure of one or more of a combination of Gaussians, a mean of individual ones of the Gaussians, or an approximated covariance of individual ones of the Gaussians, and wherein the predetermined threshold or the predetermined threshold range is applied to the statistical measure.

18. The method of claim 16, further comprising:
providing a classifier which is trained using features of the pre-trained ML model and finetuned features during the finetuning of the pre-trained ML model;
applying the predetermined threshold or the predetermined threshold range to at least one classification of the classifier; and
using the classifier to discriminate the poisoned ML model from the pre-trained ML model based in part on outliers from the at least one classification.

19. The method of claim 16, further comprising:
providing the distribution to comprise at least one statistical measure of one or more of a combination of Gaussians, a mean of individual ones of the Gaussians, or an approximated covariance of individual ones of the Gaussians;
applying the predetermined threshold or the predetermined threshold range to the at least one statistical measure; and
using the distribution to discriminate the poisoned ML model from the pre-trained ML model based in part on outliers in the distribution of the at least one statistical measure.

20. The method of claim 16, wherein the first observations and the second observations are, respectively, one or more of inferences, activations, gradients, or weights of the pre-trained ML model or from during the finetuning of the pre-trained ML model.
